(19) United States
(12) Patent Application Publication
(10) Pub. No.: US 2021/0124383 A1
(43) Pub. Date: Apr. 29, 2021

(54) TECHNIQUES FOR LOW-DROPOUT (LDO) REGULATOR START-UP DETECTION

(71) Applicant: QUALCOMM Incorporated, San Diego, CA (US)

(72) Inventors: Shunta IGUCHI, San Diego, CA (US); Michael Naone FARIAS, San Diego, CA (US)

(21) Appl. No.: 16/665,551

(22) Filed: Oct. 28, 2019

(51) Int. Cl. G05F 1/575

(52) U.S. Cl. CPC G05F 1/575; H04B 1/3827

(57) ABSTRACT

A circuit for voltage regulation and an associated method and apparatus are described. The circuit generally includes an amplifier, a pass transistor coupled to a first voltage rail node, a first switch series-coupled between an output of the amplifier and a gate of the pass transistor, and a feedback path coupled between the first voltage rail node and an input of the amplifier.

### TECHNICAL FIELD

Certain aspects of the present disclosure generally relate to electronic circuits and, more particularly, to circuits for voltage regulation.

### BACKGROUND

A voltage regulator ideally provides a constant direct current (DC) output voltage regardless of changes in load current or input voltage. Voltage regulators may be classified as either linear regulators or switching regulators. While linear regulators tend to be small and compact, many applications may benefit from the increased efficiency of a switching regulator. A linear regulator may be implemented by a low-dropout (LDO) regulator, for example. A switching regulator may be implemented by a switched-mode power supply (SMPS), such as a buck converter, a boost converter, or a buck-boost converter.

Power management integrated circuits (power management ICs or PMIC) are used for managing the power requirement of a host system and may include and/or control one or more voltage regulators (e.g., LDO regulators). A PMIC may be used in battery-operated devices, such as mobile phones, tablets, laptops, wearables, etc., to control the flow and direction of electrical power in the devices. The PMIC may perform a variety of functions for the device such as DC-to-DC conversion (using a voltage regulator as described above), battery charging, power-source selection, voltage scaling, power sequencing, etc.

### SUMMARY

Certain aspects of the present disclosure generally relate to a low-dropout (LDO) regulator.

Certain aspects of the present disclosure provide a circuit for voltage regulation. The circuit generally includes an amplifier, a pass transistor coupled to a first voltage rail node; a first switch series-coupled between an output of the amplifier and a gate of the pass transistor, and a feedback path coupled between the first voltage rail node and an input of the amplifier.

Certain aspects of the present disclosure provide a method for voltage regulation. The method generally includes comparing a feedback signal to a reference signal via an amplifier, the feedback signal being representative of a voltage at a first voltage rail node, and selectively coupling an output of the amplifier to a gate of a pass transistor via a first switch, the pass transistor being coupled to the first voltage rail node.

Certain aspects of the present disclosure provide an apparatus for voltage regulation. The apparatus generally includes means for comparing a feedback signal to a reference signal, the feedback signal being representative of a voltage at a first voltage rail node, and means for selectively coupling an output of the amplifier to a gate of a pass transistor, the pass transistor being coupled to the first voltage rail node.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a block diagram of an example device including a voltage regulator, according to certain aspects of the present disclosure.

FIG. 2 is a block diagram illustrating a multiplexer for selectively coupling one of two voltage rails to an oscillator, in accordance with certain aspects of the present disclosure.

FIG. 3 is a graph illustrating two different voltage rails, in accordance with certain aspects of the present disclosure.

FIG. 4 illustrates an example low-dropout (LDO) regulator, in accordance with certain aspects of the present disclosure.

FIG. 5 illustrates an example LDO regulator having an error amplifier selectively coupled to a pass transistor, in accordance with certain aspects of the present disclosure.

FIG. 6A illustrates an LDO regulator having a comparator, in accordance with certain aspects of the present disclosure.

FIGS. 6B-6E illustrate an LDO regulator in various configurations, in accordance with certain aspects of the present disclosure.

FIG. 7 illustrates example operations for voltage regulation, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

### AN EXAMPLE DEVICE

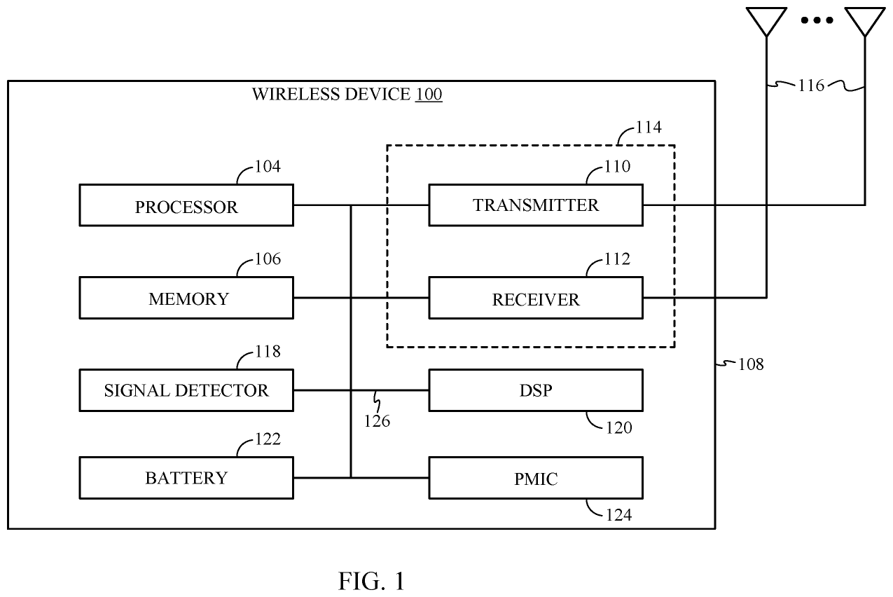

FIG. 1 illustrates a device 100. The device 100 may be a battery-operated device such as a cellular phone, a personal digital assistant (PDA), a handheld device, a wireless modem, a laptop computer, a tablet, a personal computer, etc. The device 100 is an example of a device that may be configured to implement the various systems and methods described herein.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106. The instructions in the memory 106 may be executable to implement the methods described herein.

The device 100 may also include a housing 108 that may include a transmitter 110 and a receiver 112 to allow transmission and reception of data between the device 100 and a remote location. The transmitter 110 and receiver 112 may be combined into a transceiver 114. A plurality of transmit antennas 116 may be attached to the housing 108 and electrically coupled to the transceiver 114. The device 100 may also include (not shown) multiple transmitters, multiple receivers, and multiple transceivers.

The device 100 may also include a signal detector 118 that may be used in an effort to detect and quantify the level of signals received by the transceiver 114. The signal detector 118 may detect such signals as total energy, energy per subcarrier per symbol, power spectral density and other signals. The device 100 may also include a digital signal processor (DSP) 120 for use in processing signals.

The device 100 may further include a battery 122 used to power the various components of the device 100. The device 100 may also include a power management integrated circuit (power management IC or PMIC) 124 for managing the power from the battery to the various components of the device 100. The PMIC 124 may perform a variety of functions for the device such as DC-to-DC conversion, battery charging, power-source selection, voltage scaling, power sequencing, etc. In certain aspects, the PMIC 124 includes a voltage regulator (e.g., a low-dropout (LDO) regulator) as described herein. The various components of the device 100 may be coupled together by a bus system 126, which may include a power bus, a control signal bus, and a status signal bus in addition to a data bus.

### EXAMPLE TECHNIQUES FOR LOW-DROPOUT (LDO) REGULATOR START-UP DETECTION

High-speed fifth-generation (5G) wireless networks may use higher frequency and/or a lower noise crystal oscillator reference, resulting in higher power consumption and lower days of use (DOU) (e.g., metric indicating how long a phone can last on a charge in a typical use case) compared to earlier generations. In order to mitigate the higher power consumption, the crystal oscillator subsystem may be powered from a more efficient, but noisier voltage regulator when not expected to meet stringent phase noise specifications. For instance, while the communication system is in sleep mode, a relatively more efficient switched-mode regulator may be used, as opposed to a linear regulator used during active mode.

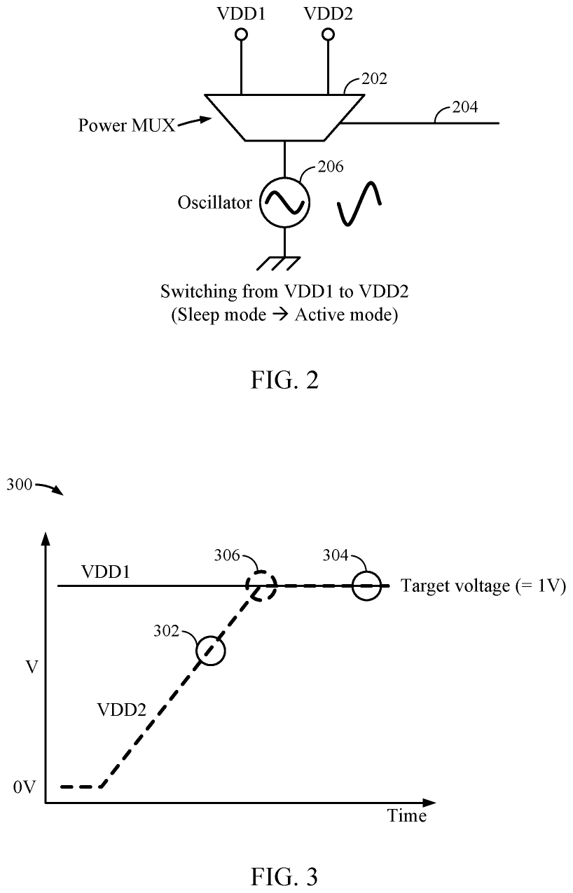

FIG. 2 is a block diagram illustrating a multiplexer (MUX) 202 for selectively coupling one of two voltage rails to an oscillator 206 based on a signal at a control input 204, in accordance with certain aspects of the present disclosure. For example, as illustrated, a first voltage rail (VDD1) may be generated using a switched-mode regulator, and a second voltage rail (VDD2) may be generated using a linear regulator (e.g., a low-dropout (LDO) regulator). The voltage rails may be provided to a power multiplexer (MUX) 202 which may be used to select one of the voltage rails for powering other circuitry. The selected voltage rail may be used for any of various suitable applications. For example, the selected voltage rail may be provided to an oscillator 206 for generation of a local oscillator (LO) signal for communication systems.

FIG. 3 is a graph 300 illustrating voltage rails VDD1 and VDD2, in accordance with certain aspects of the present disclosure. The moment in time when the voltage supplied to the oscillator 206 is switched from VDD1 to VDD2 is important. For example, as illustrated, VDD2 may begin ramping up from 0 V to a target voltage of 1 V. If the MUX 202 switches the voltage rail from VDD1 to VDD2 at time 302 (early switching), a voltage droop may be experienced at the supply node of the oscillator 206 which may result in a clock glitch. However, the MUX 202 switching the voltage rail from VDD1 to VDD2 at time 304 (late switching) may result in higher power consumption and higher latency since the radio-frequency (RF) integrated circuit (RFIC) of the communication system may have to wait for the voltage rail switch to occur. Therefore, it is preferable to switch the voltage rail provided to the oscillator 206 from VDD1 to VDD2 at time 306 at the moment VDD2 reaches VDD 1. Certain aspects of the present disclosure are generally directed to apparatus and techniques for controlling the voltage rail switching using an LDO regulator start-up detection circuit.

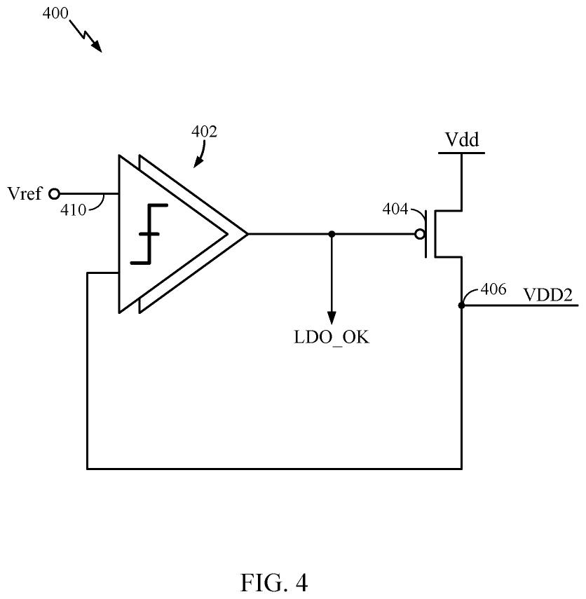

FIG. 4 illustrates an example LDO regulator 400, in accordance with certain aspects of the present disclosure. As illustrated, the LDO regulator 400 may include an error amplifier 402 having an output coupled to a gate of a pass transistor 404 (e.g., p-type metal-oxide-semiconductor (PMOS) pass field-effect transistor (FET)). The error amplifier 402 may be used to control the transistor 404 to generate a regulated output voltage (VDD2) at output node 406 using a supply voltage (VDD). In other words, VDD2 may be fed back to the error amplifier 402 and compared to a reference voltage (VREF) at a reference voltage node 410. The error amplifier 402 controls the transistor 404 such that VDD2 ramps up until VDD2 equals VREF.

In certain aspects of the present disclosure, the error amplifier 402 may also be used as a detector for detecting when to perform the voltage rail switching from VDD1 to VDD2, as described in more detail herein. The error associated with a comparator (e.g., amplifier) is related to the size of the comparator. In certain implementations, the error amplifier 402 may be designed to be a relatively large amplifier to meet various stringent noise and performance specifications. Therefore, certain aspects of the present disclosure use the error amplifier 402 of the LDO regulator as a comparator for accurately detecting when VDD2 has reached the target voltage, indicating the preferable moment in time for switching from VDD1 to VDD2 via MUX 202.

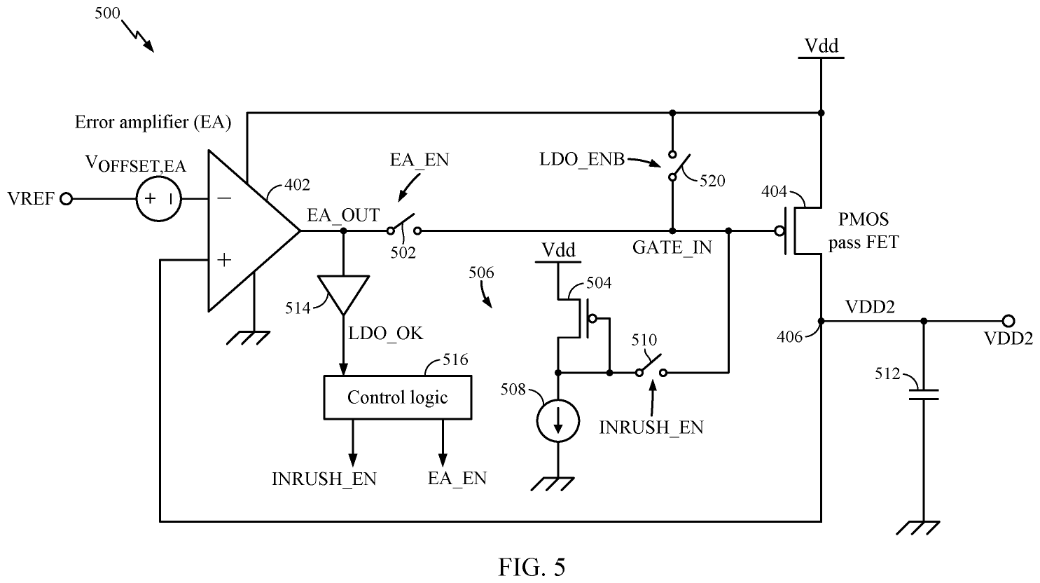

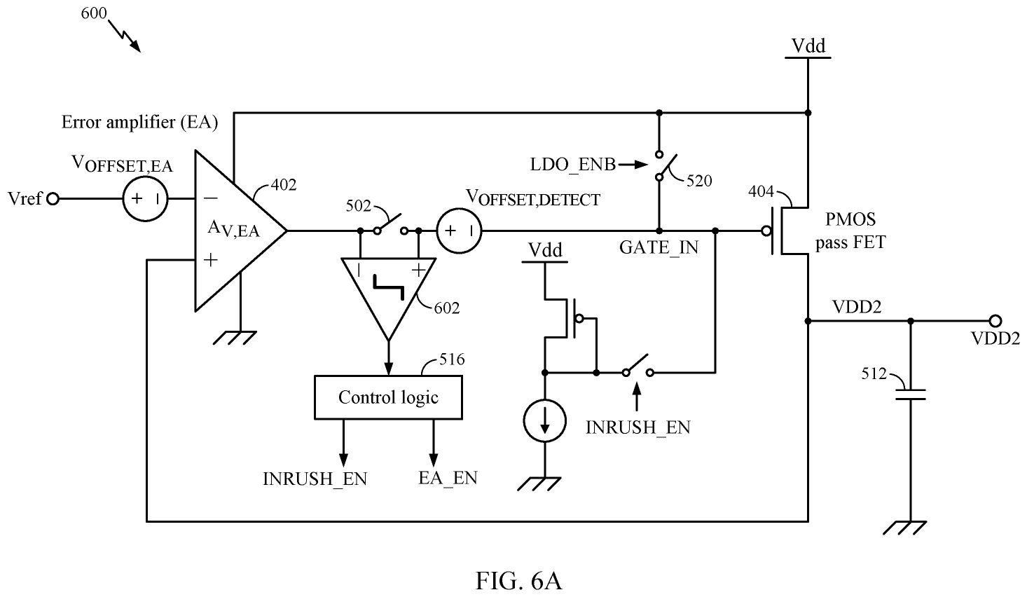

FIG. 5 illustrates an example LDO regulator 500 having the error amplifier 402 selectively coupled to the pass transistor 404, in accordance with certain aspects of the present disclosure. The LDO regulator 500 may include a switch 502 series-coupled in a signal path between the output of the error amplifier 402 and the gate of the pass transistor 404. In other words, the switch 502 selectively couples the output of the error amplifier 402 to the gate of the transistor 404. The LDO regulator 500 also includes a precharge circuit 506 (also referred to as an “inrush limit circuit”). The precharge circuit 506 may include a current mirror branch implemented using a transistor 504 (e.g., PMOS) (also referred to as a “start-up transistor”) and a current source 508. The gate of the transistor 504 is coupled to the drain of the transistor 504 and selectively coupled to the gate of transistor 404 via switch 510, as illustrated. In other words, when switch 510 is closed, the precharge circuit 506 and the pass transistor 404 form a current mirror, ramping up the voltage rail VDD2 by charging a capacitive element 512 (e.g., representing a load capacitance). Prior to a precharge phase, the switch 520 may be closed by the control logic 516 via a complementary LDO enable (LDO ENB) signal, disabling the LDO regulator 500. In other words, when the switch 520 is closed, the source and gate of the transistor 404 are shorted together, opening the transistor 404 and disabling the LDO regulator 500.

During a precharge phase, the LDO regulator 500 may be enabled by the control logic 516 via the LDO_ENB signal by opening switch 520. The control logic 516 may also open the switch 502 via an error amplifier enable (EA_EN) signal. Moreover, the switch 510 may be closed via an inrush limit enable (INRUSH_EN) signal such that a current flows from the source to the drain (e.g., output node 406) of the transistor 404, charging the capacitive element 512 and ramping up VDD2. Since the switch 502 is open (e.g., LDO regulator is configured in an open loop configuration), when VDD2 reaches VREF, as detected by the amplifier 402, the voltage at the output of the amplifier 402 (EA_OUT) transitions from 0 V (e.g., electric ground) to Vdd. This transition is detected by the control logic 516. For example, a buffer 514 may be coupled between the output of the amplifier 402 and the control logic 516 to buffer the output voltage of the amplifier 402 for detection by the control logic 516. The output of the buffer 514 may also indicate the moment when the voltage rail to be provided to the oscillator 206 is to switch from VDD1 to VDD2 via MUX 202, as described with respect to FIG. 2. Moreover, the control logic 516 may open the switch 510 at this moment and close the switch 502 in response to the voltage transition at the output of the amplifier 402, configuring the LDO regulator 500 in a closed-loop mode of operation.

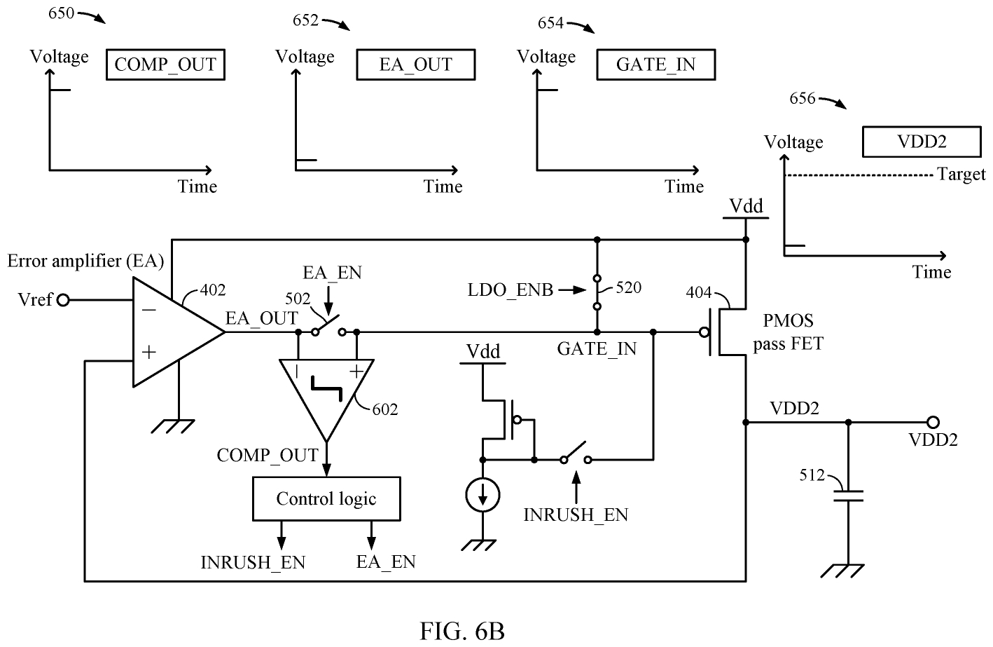

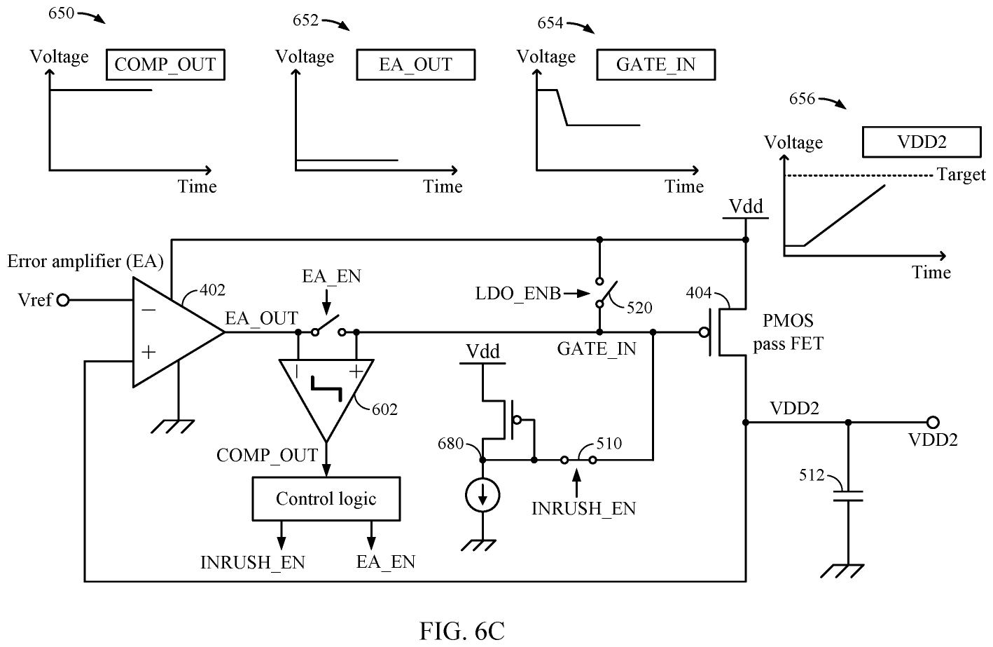

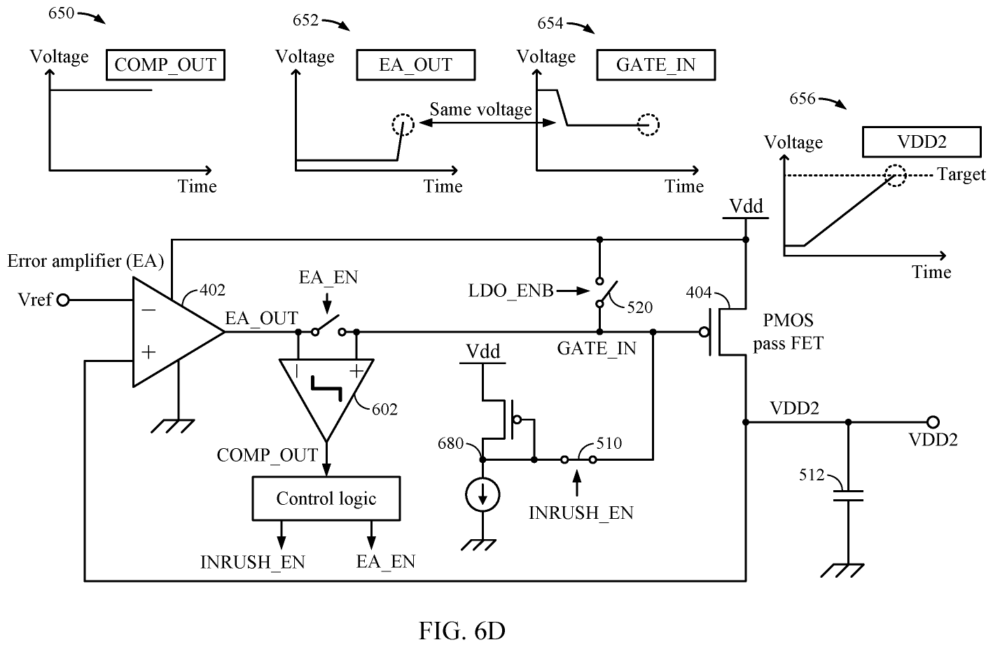

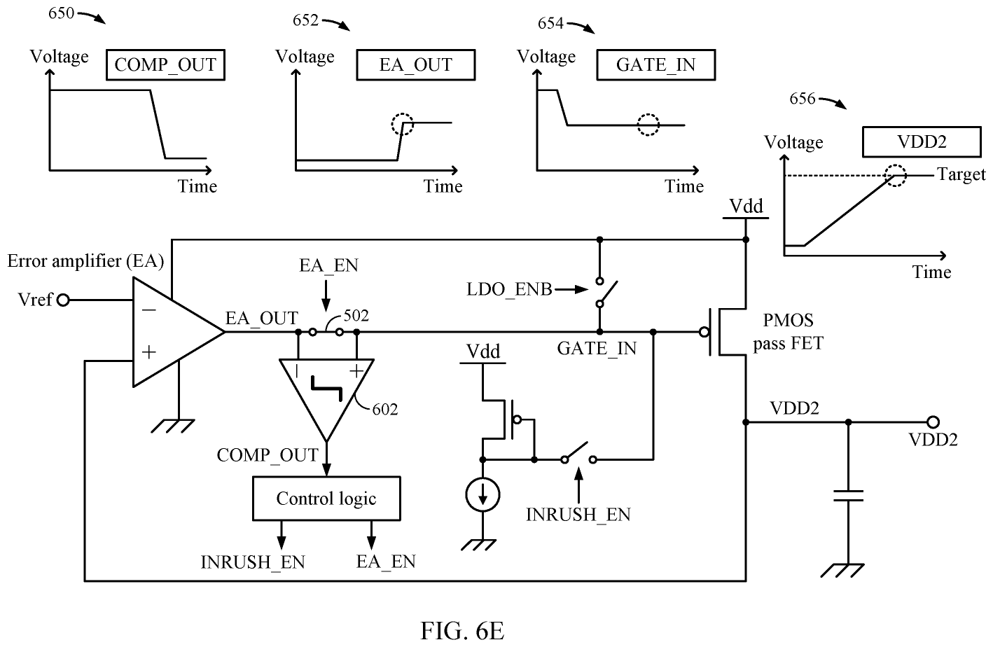

FIG. 6A illustrates an LDO regulator 600 implemented with a comparator 602, in accordance with certain aspects of the present disclosure. As illustrated, the comparator 602 may have first and second inputs (e.g., negative and positive inputs) coupled to the output of the error amplifier 402 and the gate of the transistor 404, respectively. In this manner, the comparator 602 may be configured to detect when the output of the amplifier 402 is equal to the gate voltage of the transistor 404, based on which the control logic may close the switch 502, as described in more detail herein. Moreover, the MUX 202 may be controlled based on the output signal (e.g., COMP_OUT signal) of the comparator 602. For example, when the output signal transitions from logic high to logic low, the MUX 202 may switch the voltage rail to be applied to the oscillator 206 from VDD1 to VDD2.

FIGS. 6B-6E illustrate the LDO regulator 600 in various configurations, in accordance with certain aspects of the present disclosure. As illustrated in FIG. 6B, when the LDO regulator 600 is disabled, switch 520 is closed, shorting the source and gate of the transistor 404, as described herein. Switches 502 and 510 are open. Graph 650 illustrates the voltage at the output of the comparator 602 (e.g., the COMP_OUT signal), graph 652 illustrates the voltage at the output of the amplifier 402 (e.g., EA_OUT signal), graph 654 illustrates the gate voltage of the transistor 404 (e.g., the GATE_IN signal), and graph 656 illustrates the voltage at the output of the LDO regulator 600 (e.g., VDD2). When the LDO regulator 600 is disabled, the output voltage of the comparator 602 (COMP_OUT) is logic high, the output voltage of the amplifier 402 (EA_OUT) is low, the gate voltage (GATE_IN) of the transistor 404 equals Vdd, and the output of the LDO regulator 600 (VDD2) is low.

As illustrated in FIG. 6C, during the precharge phase (also referred to as “the start-up phase”), switch 520 is opened, and switch 510 is closed by the control logic 516, resulting in the gate voltage (GATE_IN signal) of the transistor 404 dropping from Vdd to the voltage at node 680, as illustrated in graph 654. Switch 502 remains open. Moreover, as the transistor 404 begins to turn on, the capacitive element 512 begins to charge, and VDD2 rises, as illustrated in graph 656. As illustrated in FIG. 6D, the switch 510 remains closed until VDD2 equals a target voltage (e.g., VREF), as illustrated in graph 656, at which point, the output voltage of the amplifier 402 (EA_OUT) rises until EA_OUT is equal to the gate voltage (GATE_IN) of the transistor 404, as illustrated in graphs 652, 654. The comparator 602 detects that EA_OUT is equal to GATE_IN and the output voltage of the comparator 602 (COMP_OUT) drops to logic low (a reference potential, such as electric ground or 0 V), as illustrated in graph 650 of FIG. 6E. When COMP_OUT drops to logic low, the control logic 516 closes switch 502, configuring the LDO regulator 600 in a closed-loop configuration, as described herein.

The error associated with detecting when VDD2 reaches the target voltage (e.g., VREF) may be represented by the total voltage offset (V_{OFFSET,TOTAL}) associated with the amplifier 402 and the comparator 602. For example, V_{OFFSET,TOTAL} may be equal to V_{OFFSET,EA}+V_{OFFSET,DETECT}/A_{V,EA,} where V_{OFFSET,EA} is the voltage offset associated with the amplifier 402, V_{OFFSET,DETECT} is the voltage offset associated with the comparator 602, and A_{V,EA} is the gain of the amplifier 402, as illustrated in FIG. 6A. The error associated with detecting when VDD2 reaches the target voltage (VREF) may be about ten times less than conventional implementations in which a separate detector (e.g., a different comparator than the amplifier 402) is used to compare VDD2 to a reference voltage.

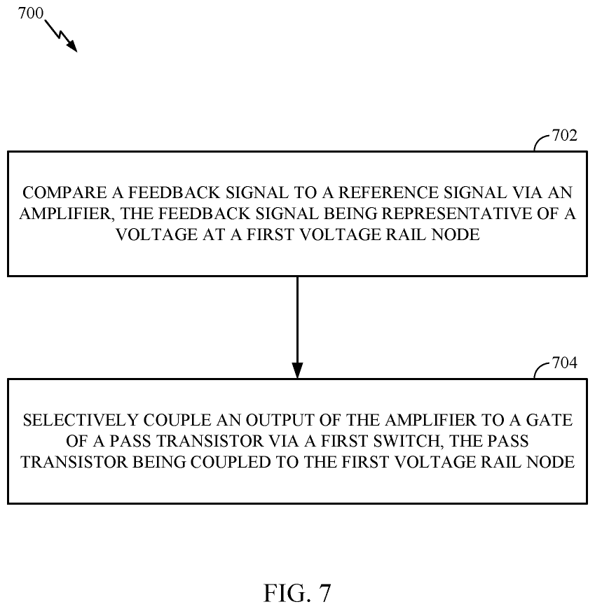

FIG. 7 illustrates example operations 700 for voltage regulation, in accordance with certain aspects of the present disclosure. The operations 700 may be performed by a voltage regulation circuit, such as the LDO regulator 400, 500, or 600 and the MUX 202.

The operations 700 begin at block 702 with the voltage regulation circuit comparing a feedback signal to a reference signal (e.g., VREF) via an amplifier (e.g., amplifier 402), the feedback signal being representative of a voltage (e.g., VDD2) at a first voltage rail node (e.g., output node 406), and at block 704, selectively coupling an output of the amplifier to a gate of a pass transistor (e.g., transistor 404) via a first switch (e.g., switch 502), the pass transistor being coupled to the first voltage rail node. In certain aspects, the operations 700 also include coupling start-up circuitry (e.g., precharge circuit 506) to the gate of the pass transistor during a start-up phase, where the output of the amplifier is coupled to the gate of the pass transistor by closing the first switch after the start-up phase. In certain aspects, the operations 700 also include the voltage regulation circuit biasing (e.g., via the precharge circuit 506) the pass transistor via start-up circuitry during a start-up phase, where the output of the amplifier is coupled to the gate of the pass transistor by closing the first switch after the start-up phase.

In certain aspects, the operations 700 also include the voltage regulation circuit determining (e.g., via comparator 602) a voltage difference between terminals of the first switch, and controlling the first switch based on the determination. In certain aspects, the operations 700 also include the voltage regulation circuit selecting (e.g., via MUX 202) the first voltage rail node or a second voltage rail node based on the comparison of the feedback signal to the reference signal.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with discrete hardware components designed to perform the functions described herein. The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

1. A circuit for voltage regulation, comprising:
a multiplexer having a first input coupled to a first voltage rail node and a second input coupled to a second voltage rail node, the multiplexer being configured to select one of the first voltage rail node and the second voltage rail node to electrically couple to a supply node of another circuit;
an amplifier, an output of the amplifier being coupled to a control input of the multiplexer;
a pass transistor coupled to the first voltage rail node;
a first switch series-coupled between the output of the amplifier and a gate of the pass transistor; and
a feedback path coupled between the first voltage rail node and an input of the amplifier.

2. The circuit of claim 1, further comprising:
start-up circuitry; and
a second switch series-coupled between the start-up circuitry and the gate of the pass transistor.

3. The circuit of claim 2, wherein the start-up circuitry comprises a current mirror branch, and wherein the current mirror branch and the pass transistor form a current mirror when the second switch is closed.

4. The circuit of claim 3, wherein the current mirror branch comprises:
a current source; and
a start-up transistor having a gate coupled to the current source and to a drain of the start-up transistor, the second switch being series-coupled between the gate of the start-up transistor and the gate of the pass transistor.

5. The circuit of claim 1, further comprising:
a buffer coupled to the output of the amplifier; and
control logic coupled to an output of the buffer, the control logic being configured to control the first switch.

6. The circuit of claim 1, further comprising a comparator having a first input coupled to a first terminal of the first switch and a second input coupled to a second terminal of the first switch, wherein the first terminal of the first switch is coupled to the output of the amplifier, and wherein the second terminal of the first switch is coupled to the gate of the pass transistor.

7. The circuit of claim 6, further comprising:
control logic configured to control the first switch based on an output signal generated by the comparator.

8. The circuit of claim 7, wherein the control logic is configured to close the first switch when a voltage at the first terminal of the first switch is higher than a voltage at the second terminal of the first switch.

9. The circuit of claim 1, wherein the other circuit comprises an oscillator.

10. The circuit of claim 1, further comprising a second switch coupled between a source and a gate of the pass transistor.

11. A method for voltage regulation, comprising:
comparing a feedback signal to a reference signal via an amplifier, the feedback signal being representative of a voltage at a first voltage rail node;
selectively coupling an output of the amplifier to a gate of a pass transistor via a first switch, the pass transistor being coupled to the first voltage rail node; and
selecting, via a multiplexer, one of the first voltage rail node and a second voltage rail node to electrically couple to a supply node of another circuit, the output of the amplifier being coupled to a control input of the multiplexer.

12. The method of claim 11, further comprising coupling start-up circuitry to the gate of the pass transistor during a start-up phase, wherein the output of the amplifier is coupled to the gate of the pass transistor by closing the first switch after the start-up phase.

13. The method of claim 11, further comprising biasing the pass transistor via start-up circuitry during a start-up phase, wherein the output of the amplifier is coupled to the gate of the pass transistor by closing the first switch after the start-up phase.

14. The method of claim 13, wherein the biasing of the pass transistor comprises closing a second switch coupled between the gate of the pass transistor and the start-up circuitry.

15. The method of claim 13, further comprising deactivating the voltage regulation prior to the start-up phase by closing a second switch coupled between a gate and a source of the pass transistor.

16. The method of claim 11, further comprising:
determining a voltage difference between terminals of the first switch; and
controlling the first switch based on the determination.

17. The method of claim 11, wherein the other circuit comprises an oscillator.

18. An apparatus for voltage regulation, comprising:
means for comparing a feedback signal to a reference signal, the feedback signal being representative of a voltage at a first voltage rail node;
means for selectively coupling an output of the means for comparing to a gate of a pass transistor, the pass transistor being coupled to the first voltage rail node; and
means for selecting one of the first voltage rail node and a second voltage rail node to electrically couple to a supply node of a circuit, the means for comparing being configured to control the means for selecting.

19. The apparatus of claim 18, further comprising means for coupling start-up circuitry to the gate of the pass transistor during a start-up phase, wherein the output of the means for comparing is coupled to the gate of the pass transistor after the start-up phase.

20. The apparatus of claim 18, further comprising means for biasing the pass transistor during a start-up phase, wherein the output of the means for comparing is coupled to the gate of the pass transistor after the start-up phase.
